(19) United States
(12) Patent Application Publication
(10) Pub. No.: US 2026/0312286 A1
(43) Pub. Date: Oct. 8, 2026

(54) RADIATING ELEMENT AND BASE STATION ANTENNA

(71) Applicant: Outdoor Wireless Networks LLC, Claremont, NC (US)

(72) Inventors: Jian ZHANG, Suzhou, Jiangsu (CN); Changfu CHEN, Suzhou, Jiangsu (CN); Cheng XUE, Suzhou, Jiangsu (CN); Bin SUN, Suzhou, Jiangsu (CN); Fei LI, Suzhou, Jiangsu (CN)

(21) Appl. No.: 18/998,423

(22) PCT Filed: Jul. 25, 2023
(86) PCT No.: PCT/US2023/070880

§ 371 Date: Jan. 24, 2025

(30) Foreign Application Priority Data
Aug. 5, 2022 (CN) 202210935204.9

(51) Int. Cl. H01Q 5/10; H01Q 1/24; H01Q 1/38; H01Q 19/00

(52) U.S. Cl. CPC H01Q 5/10; H01Q 1/38; H01Q 19/005; H01Q 1/246

(57) ABSTRACT

The present disclosure relates to a radiating element, and the radiating element includes: a radiator with a radiating arm, the radiator configured to emit first electromagnetic radiation within a predetermined first operating frequency band; and a parasitic metal pattern, where a resonant circuit is formed between the radiating arm of the radiator and the parasitic metal pattern, and the resonant circuit is configured to allow an operating current on the radiating arm within the first operating frequency band to pass, but prevent an inductive current induced on the radiating arm and within a second operating frequency band. In addition, the present disclosure also relates to a base station antenna having the radiating element (FIG. 4).

### RELATED APPLICATION

The present application claims priority from and the benefit of Chinese Patent Application No. 202210935204.9, filed Aug. 5, 2022, the disclosure of which is hereby incorporated herein by reference in full.

### Technical Field

The present disclosure generally relates to radio communications and more particularly, to a radiating element and a related base station antenna.

### BACKGROUND

Cellular communications systems are well known in the art. In a cellular communications system, a geographic area is divided into a series of sections that are referred to as “cells” which are served by respective base stations. Each base station may include one or more base station antennas that are configured to provide two-way radio frequency (“RF”) communications with mobile subscribers that are within the cell served by the base station.

In many cases, each base station is divided into “sectors”. In the most common configuration, a hexagonally shaped cell is divided into three 120° sectors, and each sector is served by one or more base station antennas that produce a radiation pattern or an “antenna beam” with an azimuth half power beam width (HPBW) of approximately 65°. Typically, the base station antennas are mounted on a tower structure, with the antenna beams that are generated by the base station antennas directed outwardly. Base station antennas are often realized as linear or planar phased arrays of radiating elements.

In order to accommodate the ever-increasing volumes of cellular communications, cellular operators have added cellular services in a variety of new frequency bands. In some cases it is possible to use linear arrays of so-called “wideband” or “ultra-wideband” radiating elements to provide service in a plurality of frequency bands, but in other cases it is necessary to use different linear arrays or planar arrays of radiating elements to support service in the different frequency bands.

As the number of frequency bands has proliferated, increased sectorization has become more common (e.g., dividing a cell into six, nine or even twelve sectors), and the number of base station antennas deployed at a typical base station has increased significantly. However, due to local zoning ordinances and/or weight and wind loading constraints for the antenna towers, there is often a limit as to the number of base station antennas that can be deployed at a given base station. In order to increase capacity without further increasing the number of base station antennas, so-called multi-band antennas have been introduced in which a plurality of linear arrays of radiating elements are included in a single antenna. One very common multi-band antenna includes a linear array of “low-band” radiating elements that are used to provide service in some or all of the 617 to 960 MHz frequency band, and a linear array of “mid-band” radiating elements that are used to provide service in some or all of the 1427 to 2690 MHz frequency band. These linear arrays of low-band and mid-band radiating elements are typically mounted in a side-by-side fashion.

However, in multi-band antennas, radiating elements in different frequency bands may interfere with each other. For example, low-band radiating elements may produce relatively large scattering effects on nearby mid-band radiating elements and/or high-band radiating elements, thereby affecting the performance, such as the lobe width and the like of the mid-band radiating elements and/or high-band radiating elements.

To avoid the above-described scattering effects, chokes may be introduced on radiating arms of low-band radiating elements in some known prior art, thereby suppressing mid-band currents and/or high-band currents excited on the radiating arms. In some cases, the choke may be formed by using a gap introduced for interrupting the radiating arm. In some cases, the choke may be formed by using a bending section that functions as an inductive section.

FIG. 1 is a schematic diagram of a radiator 1 of a low-band radiating element known in the prior art. Each of the four radiating arms of the radiator 1 may be interrupted into a plurality of arm sections 2. The various arm sections 2 may be connected via bent narrower inductive sections 3, which may function as chokes. FIG. 2 is a simplified equivalent circuit diagram of a resonant circuit on the radiating arm of the radiating element of FIG. 1. The arm section 2 of the radiating arm may function as a capacitive section, and the bent narrower section 3 may function as an inductive section. As such, the capacitive section and the inductive section may form an LC series resonant circuit, which may be configured to inhibit a mid-band current and/or a high-band current excited on the radiating arm. It should be understood that the equivalent circuit diagram of the resonant circuit is a simplified circuit diagram, in which parasitic capacitors and/or parasitic inductances, which are negligible in value, are omitted. For example, parasitic capacitors may be provided between two adjacent arm sections.

However, with the choke, the radiation performance of the low-band radiating elements per se may be negatively affected. In some cases, the choke may undesirably get changed, for example, an increased the impedance of the low-band radiating elements, making impedance matching difficult, thereby causing return loss to deteriorate. Further, the choke may undesirably increase the radiation loss of the low-band radiating elements, causing antenna gain to decrease. These problems become more prominent as the number of chokes on the radiating arm increases.

### SUMMARY

Therefore, the objective of the present disclosure is to provide a radiating element and a base station antenna capable of overcoming at least one drawback in the prior art.

According to a first aspect of the present disclosure, a radiating element is provided, which comprises:
a radiator with a radiating arm, the radiator configured to emit first electromagnetic radiation within a predetermined first operating frequency band; and
a parasitic metal pattern, wherein a resonant circuit is formed between the radiating arm of the radiator and the parasitic metal pattern, wherein the resonant circuit is configured to allow an operating current on the radiating arm and within the first operating frequency band to pass, but prevent an inductive current inducted on the radiating arm and within a second operating frequency band.

According to a second aspect of the present disclosure, a radiating element is provided, which comprises:
a dielectric substrate;
a radiator arranged on a first major surface of the dielectric structure, the radiator configured to emit first electromagnetic radiation within a predetermined first operating frequency band; and
a parasitic metal pattern arranged on a second major surface of the dielectric structure, the parasitic metal pattern configured to interact with the radiator electromagnetically for inhibiting an inductive current induced on the radiator and within a second operating frequency band.

According to a third aspect of the present disclosure, a base station antenna is provided, which comprises: a first radiating element array configured to emit first electromagnetic radiation within a pre-determined first operating frequency band, wherein at least a part of first radiating elements in the first radiating element array is constructed as the radiating element according to some embodiments of present disclosure and a second radiating element array, configured to emit second electromagnetic radiation within a pre-determined second operating frequency band.

### BRIEF DESCRIPTION OF DRAWINGS

The present disclosure will be explained in greater detail by means of specific embodiments with reference to the attached drawings. The schematic drawings are briefly described as follows:

FIG. 1 is a schematic diagram of a radiator of a radiating element known in the prior art, which has a plurality of chokes.

FIG. 2 is a simplified equivalent circuit diagram of a resonant circuit formed on the radiator of FIG. 1.

FIG. 3 is a schematic perspective view of a base station antenna according to some embodiments of the present disclosure, where a radome is removed.

FIG. 4 is a schematic perspective view of a radiating element according to some embodiments of the present disclosure, where a feeder pillar is not shown.

FIG. 5 is a schematic diagram of a radiator of the radiating element in FIG. 4.

FIG. 6 is a schematic diagram of a parasitic metal pattern of the radiating element in FIG. 4.

FIG. 7A and FIG. 7B are some variations of a radiator of a radiating element according to some embodiments of the present disclosure.

FIG. 8A, FIG. 8B, FIG. 8C and FIG. 8D are some variations of a parasitic metal pattern of a radiating element according to some embodiments of the present disclosure.

FIG. 9 is a schematic perspective view of a radiating element according to some other embodiments of the present disclosure, where a feeder pillar is not shown.

FIG. 10 is a schematic diagram of a radiator of the radiating element in FIG. 9.

FIG. 11 is a schematic diagram of a parasitic metal pattern of the radiating element in FIG. 9.

FIG. 12 is a simplified equivalent circuit diagram of a resonant circuit formed on a radiating element according to some embodiments of the present disclosure.

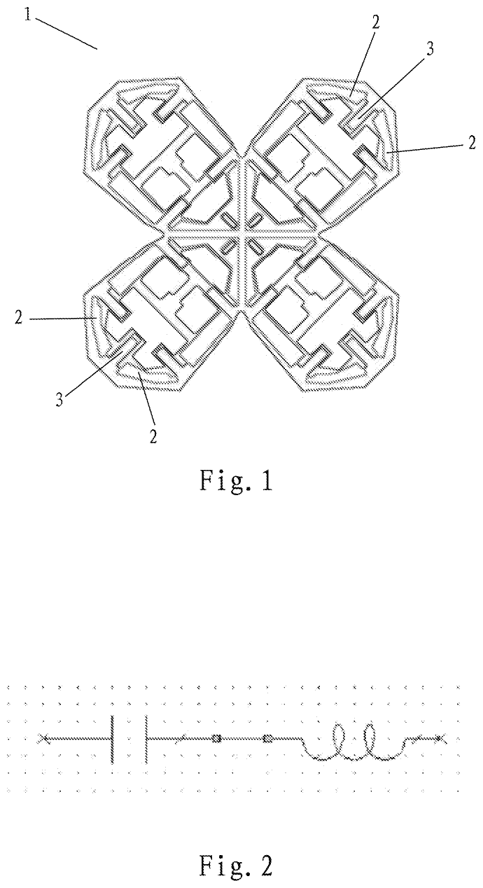

### DETAILED DESCRIPTION OF SPECIFIC EMBODIMENTS

The present disclosure will be described below with reference to the attached drawings, wherein the attached drawings illustrate certain embodiments of the present disclosure. However, it should be understood that the present disclosure may be presented in many different ways and is not limited to the embodiments described below; in fact, the embodiments described below are intended to make the disclosure of the present disclosure more complete and to fully explain the protection scope of the present disclosure to those of ordinary skill in the art. It should also be understood that the embodiments disclosed in the present disclosure may be combined in various ways so as to provide more additional embodiments.

It should be understood that the terms used herein are only used to describe specific embodiments, and are not intended to limit the scope of the present disclosure. All terms used herein (including technical terms and scientific terms) have meanings normally understood by those skilled in the art unless otherwise defined. For brevity and/or clarity, well-known functions or structures may not be further described in detail.

As used herein, spatial relationship terms such as “upper”, “lower”, “left”, “right”, “front”, “back”, “high”, and “low” can explain the relationship between one feature and another in the attached drawings. It should be understood that, in addition to the orientations shown in the attached drawings, the terms expressing spatial relations also comprise different orientations of a device in use or operation. For example, when a device in the attached drawings rotates reversely, the features originally described as being “below” other features now can be described as being “above” the other features”. The device may also be oriented by other means (rotated by 90 degrees or at other locations), and at this time, a relative spatial relation will be explained accordingly.

As used herein, the term “A or B” comprises “A and B” and “A or B”, not exclusively “A” or “B”, unless otherwise specified.

As used herein, the term “schematic” or “exemplary” means “serving as an example, instance or explanation”, not as a “model” to be accurately copied”. Any realization method described exemplarily herein may not be necessarily interpreted as being preferable or advantageous over other realization methods. Furthermore, the present disclosure is not limited by any expressed or implied theory given in the above technical field, background art, summary of the invention or embodiments.

As used herein, the word “basically” means including any minor changes caused by design or manufacturing defects, device or component tolerances, environmental influences, and/or other factors.

As used herein, the term “partially” may be a part of any proportion. For example, it may be greater than 10%, 20%, 30%, 40%, 50%, 60%, 70%, 80%, 90%, or may even be 100%, i.e. all.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

The present disclosure relates to a radiating element, which may include a feeder pillar, a radiator, and a parasitic metal pattern, and a desired resonant circuit may be formed between the radiator and the parasitic metal pattern, so that the radiating element has cloaking performance that meets predetermined design requirements. Cloaking performance of the radiating element may be understood as transparency or otherwise invisibility of the radiating element to electromagnetic radiation within a specific operating frequency band (hereinafter referred to as a second operating frequency band) that is outside of the operating frequency band (hereinafter referred to as a first operating frequency band) thereof, such that the electromagnetic radiation within the second operating frequency band may be basically unaffected by the low loss of the radiating elements and radiate forwardly in a low distortion manner. In other words, cloaking performance of the radiating element may be understood as the inhibitory effect or attenuation effect of the radiating element on the induced current in the second operating frequency band, such that the radiating element is basically unable to outwardly radiate scattered electromagnetic radiation in the second operating frequency band.

Based on the electromagnetic effects between the radiator and the parasitic metal pattern, the radiating element according to the present disclosure can still effectively achieve the inhibitory effect or attenuation effect on the induced current in the second operating frequency band without the choke or with fewer chokes, thereby improving the impedance matching performance of the radiating element.

Embodiments of the present disclosure will now be described in greater detail with reference to the accompanying drawings.

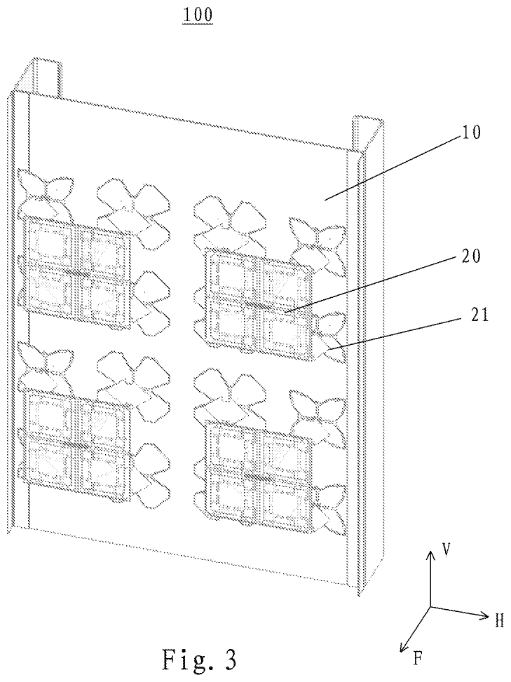

FIG. 3 is a schematic perspective view of a base station antenna 100 according to some embodiments of the present disclosure, where a radome is removed.

The base station antenna 100 may be mounted on an elevated structure, for example, an antenna tower, a utility pole, a building, or a water tower, such that the longitudinal axis thereof extends substantially perpendicular to the ground.

The base station antenna 100 is usually mounted in a radome (not shown) that provides environmental protection. The base station antenna 100 may include a reflector 10, which may include a metal surface that provides a ground plane and reflects electromagnetic waves reaching the reflector, for example, electromagnetic waves are redirected to propagate forwardly.

The base station antenna 100 may include a radiating element array arranged at the front of the reflector 10. The radiating element array may include a plurality of columns of radiating elements arranged along a longitudinal direction V. The longitudinal direction V may be the direction of the longitudinal axis of the base station antenna 100 or may be parallel to the longitudinal axis. The longitudinal direction V is perpendicular to a horizontal direction H and a forward direction F. Each radiating element is mounted to extend forwardly (along the forward direction F) from the reflector 10.

The base station antenna 100 may be a multi-band antenna. The term “multi-band antenna” refers to an antenna having two or more radiating elements operating in different frequency bands. Multi-band antennas include dual-band antennas and antennas that support service in three or more frequency bands.

In the illustrated embodiment, the base station antenna 100 may include a plurality of columns of first radiating elements 20 and a plurality of columns of second radiating elements 21 arranged at the front of the reflector 10. An operating frequency band of the first radiating element 20 may be, for example, 617 to 960 MHz or a sub-band thereof. An operating frequency band of the second radiating element 21 may be, for example, 1427 to 2690 MHz or a sub-band thereof. In other words, the first radiating element 20 may be configured as a low-band radiating element that is capable of operating within the pre-determined first operating frequency band and emit first electromagnetic radiation within the first operating frequency band. The second radiating element 21 may be configured as a mid-band radiating element to operate within the pre-determined second operating frequency band and emit second electromagnetic radiation within the second operating frequency band. The first radiating element 20 may extend forwardly from the reflector 10 farther than the second radiating element 21.

Depending on how the first radiating element 20 is fed, each column of first radiating elements 20 may be configured to form a plurality of separated first antenna beams (for each polarization) within the first operating frequency band, or may be configured to form a single antenna beam (for each polarization) within the first operating frequency band. Depending on how the second radiating element 21 is fed, each column of second radiating elements 21 may be configured to form a plurality of separated second antenna beams (for each polarization) within the second operating frequency band, or may be configured to form a single second antenna beam (for each polarization) within the second operating frequency band.

It should be understood that the base station antenna 100 may further include a plurality of columns of third radiating elements (not shown) arranged at the front of the reflector 10. The third radiating element may be constructed as a high-band radiating element, and the operating frequency band thereof may be, for example, 3.1 to 4.2 GHz or the sub-band thereof.

The radiating element 20 according to some embodiments of the present disclosure may be a low-frequency radiating element, that is, the above first radiating element 20. In other embodiments, the radiating element 20 according to some embodiments of the present disclosure may also be a wideband radiating element, and the operating frequency band thereof may not be limited to the first operating frequency band.

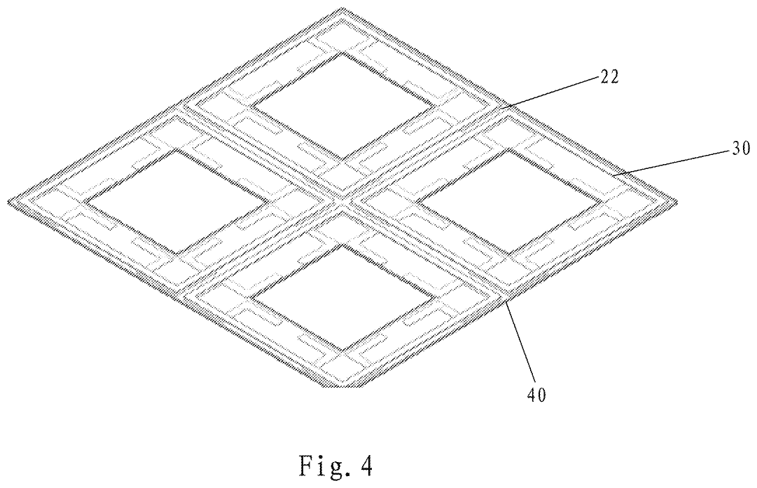

Next, referring to FIG. 4 to FIG. 6, the radiating element 20 according to some embodiments of the present disclosure will be described in detail. The radiating element 20 may include a radiator 30 and a parasitic metal pattern 40. Based on the electromagnetic effects between the radiator 30 and the parasitic metal pattern 40, a desired scattering suppression effect is effectively achieved when the radiator 30 does not have a choke or only has fewer chokes. A resonant circuit 50 is formed based on the electromagnetic effects between the radiator 30 and the parasitic metal pattern 40 in the present disclosure. The resonant circuit 50 may be configured to allow an operating current on the radiator 30 within a first operating frequency band to pass, but prevent formation of induced currents on the radiator 30 and within a second operating frequency band.

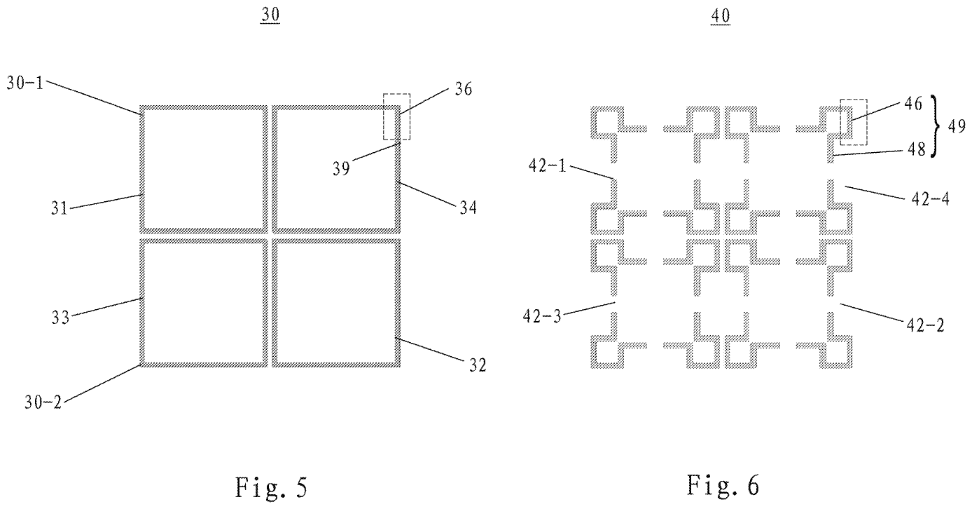

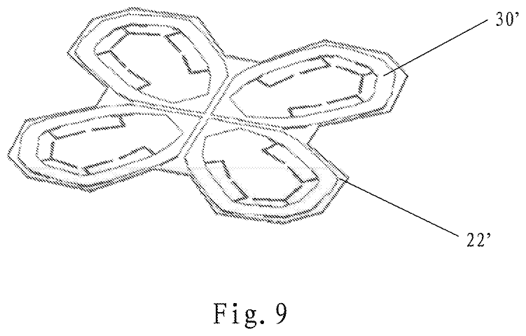

As shown in FIG. 4 and FIG. 5, the radiating element 20 may include a first dipole radiator 30-1 for first polarization and a second dipole radiator 30-2 for second polarization, the first dipole radiator 30-1 may include a first dipole arm 31 and a second dipole arm 32, and the second dipole radiator 30-2 may include a third dipole arm 33 and a fourth dipole arm 34. In some embodiments, each dipole arm may be an annular radiating arm. As shown in the figure, each dipole arm may be a square loop radiating arm. It should be understood that the dipole arm shapes may be varied and are not limited thereto. In some embodiments, the dipole arm may be a rod-shaped dipole arm. In some embodiments, the dipole arm may be a polygonal radiating arm, such as a rhombus radiating arm. In some embodiments, the dipole arm may be a ring radiating arm or a petal-shaped radiating arm (see FIG. 9).

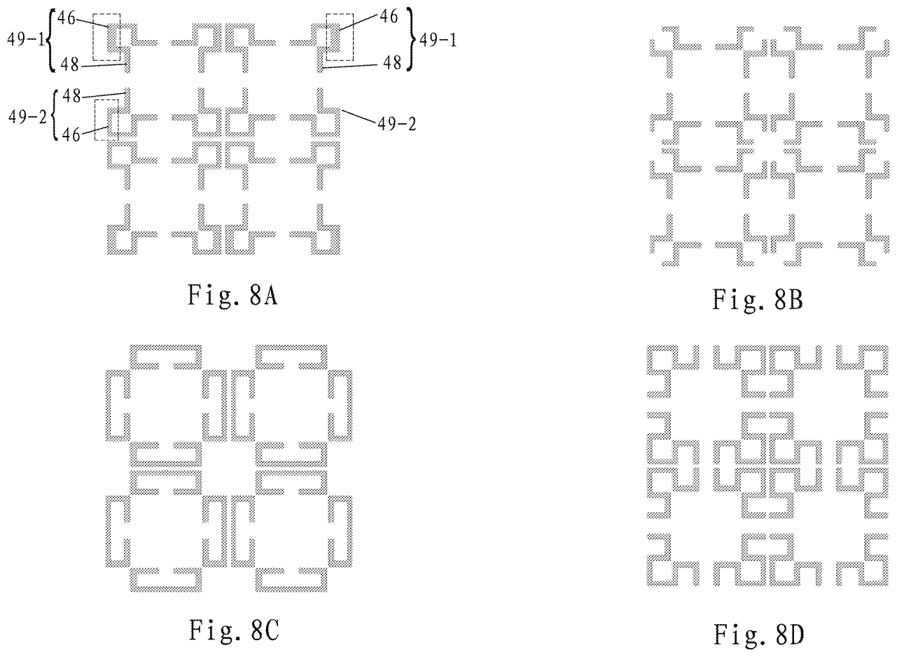

As shown in FIG. 4 and FIG. 6, the parasitic metal pattern 40 of the radiating element 20 may include a first pattern portion 42-1 for the first dipole arm 31, a second pattern portion 42-2 for the second dipole arm 32, a third pattern portion 42-3 for the third dipole arm 33, and a fourth pattern portion 42-4 for the fourth dipole arm 34. The various pattern portions 42 may be pattern units that are separate from each other or pattern units that are continuous. It may also be possible that only some of the dipole arms 31, 32, 33, 34 are assigned corresponding pattern portions 42. In some embodiments, each pattern portion 42 may be configured as a pattern unit of substantially the same shape. In other embodiments, at least some of the pattern portions 42 may have different shapes. The various pattern portions 42 may have profiles substantially corresponding to the dipole arms 31, 32, 33, and 34. For example, each pattern portion 42 may have a square or a circular profile. In order to create a symmetric electromagnetic environment, the parasitic metal pattern 40 of the radiating element 20 may have an arranged structure of axial symmetry and/or central symmetry. FIG. 8A, FIG. 8B, FIG. 8C, and FIG. 8D show some variations of the parasitic metal pattern 40. It should be understood that there may be various design forms of the parasitic metal pattern 40. In other embodiments, the parasitic metal pattern 40 may be configured as a metamaterial surface of a unit having a periodic arrangement. In some embodiments, the parasitic metal pattern 40 may be configured as a patch element.

The radiating element 20 may include a dielectric structure, such as a dielectric substrate 22, the radiator 30 may be arranged on a first major surface of the dielectric substrate 22, and the parasitic metal pattern 40 may be arranged on a second major surface of the dielectric substrate 22. As such, the parasitic metal pattern 40 may be arranged behind or in front of the radiator 30, for example, substantially parallel to the radiator 30, so as to form desired electromagnetic effects between the dipole arms 31, 32, 33, and 34 and the corresponding pattern portions 42, thereby forming a desired resonant circuit 50.

It should be understood that a dielectric structure of the radiating element 20 may have a variety of configuration methods. In some embodiments, the dielectric structure of the radiating element 20 may be a support structure made of a dielectric material (such as plastic, resin, or ceramic). In some embodiments, the dielectric structure of the radiating element 20 may be a dielectric substrate of a printed circuit board.

In the illustrated embodiment, the radiator 30 may be a printed metal radiator 30 that may be printed onto the first major surface of the dielectric substrate 22 as a printed pattern. The parasitic metal pattern 40 may be printed onto the second major surface of dielectric substrate 22 as a printed metal pattern. In other embodiments, the radiator 30 may be a metal plate radiator 30 that may be secured (e.g., bonded, snapped, and/or threaded) on the first major surface of the dielectric substrate 22. In other embodiments, the parasitic metal pattern 40 may be a face-like metal structure that may be secured (e.g., bonded, snapped, and/or threaded) on the second major surface of the dielectric substrate 22.

Next, referring to FIGS. 4-6 and 12, the resonant circuit 50 formed on the radiating element 20 is introduced.

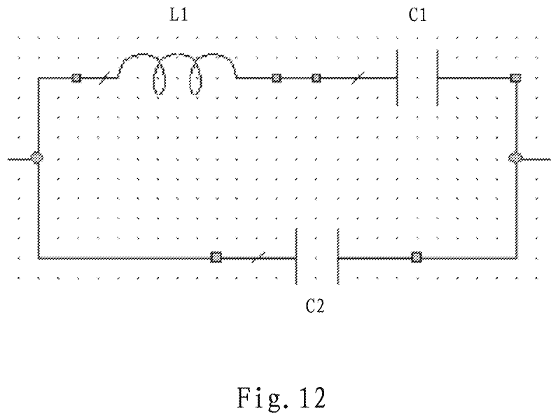

As shown in FIG. 12, the resonant circuit 50 may include an LC series circuit and a capacitor in parallel with the LC series circuit.

The capacitor (hereinafter referred to as a first capacitor C1) in the LC series circuit may be formed by coupling between the dipole arms 31, 32, 33, and 34 and the corresponding pattern portions 42. As shown in FIGS. 5-6, the corresponding dipole arms 31, 32, 33, and 34 may each include a first coupling section 36 (shown in the dotted box). The parasitic metal pattern 40 may include a second coupling section 46 (shown in the dotted box) that at least partially overlaps with the first coupling section 36 in a forward direction F. As such, the first coupling section 36, the second coupling section 46, and the dielectric substrate 22 therebetween may form a plate capacitor. An inductor (hereinafter referred to as a first inductor L1) in the LC series circuit may be formed by inductive sections 48 in the pattern portions 42. These inductive sections 48 may be inductive stubs or bent inductive traces. In present disclosure, the inductive sections 48 can be understood as a section whose frequency characteristic is approximately equivalent to an inductance. For example, when the S-parameter frequency characteristic of a section 48, eg the frequency characteristic curves of the S11 and/or S12 parameters, are approximately equivalent to that of an inductance, this section 48 then can be regarded as an inductive section.

A capacitor (hereinafter referred to as a second capacitor C2) in parallel with the LC series circuit may be formed by a predetermined-length capacitive arm section 39 of the dipole arms 31, 32, 33, and 34. In present disclosure, the capacitive arm section 39 can be understood as a section whose frequency characteristic is approximately equivalent to a capacitor. For example, when the S-parameter frequency characteristic of an arm section 39, eg the frequency characteristic curves of the S11 and/or S12 parameters, are approximately equivalent to that of a capacitor, this arm section then can be regarded as a capacitive arm section.

It should be understood that the equivalent circuit diagram of the resonant circuit shown in FIG. 12 is a simplified circuit diagram, in which parasitic capacitors and/or parasitic inductances, which are negligible in value, are omitted. For example, parasitic capacitors may be provided between two adjacent inductive sections 48 in the parasitic metal pattern 40 and these parasitic capacitors are however negligible.

It should be understood that a resonant frequency of the resonant circuit 50 may be related to an overlap area between the first coupling section 36 and the second coupling section 46, a thickness and a dielectric constant of the dielectric substrate 22, a design parameter of the inductive stub 48, and/or a design parameter of the capacitive arm section 39 of the dipole arms 31, 32, 33, and 34. In some embodiments, the resonant circuit 50 may be a band-pass resonant circuit. In some embodiments, the resonant circuit 50 may be a low-pass resonant circuit or a band-stop resonant circuit. The resonant circuit 50 may be configured such that the first operating frequency band is within a passband of the resonant circuit 50 (for example, the 3 dB passband), and the second operating frequency band is outside the passband of the resonant circuit 50.

A multi-stage resonant circuit 50 may be formed between the dipole arms 31, 32, 33, and 34 and the corresponding pattern portions 42, further improving the frequency characteristic of the resonant circuit 50. As shown in FIG. 5, each pattern portion 42 may include a plurality of sub-patterns 49, for example, separated from one another. Each sub-pattern 49 may include the second coupling section 46 and the inductive section 48 mentioned above, and each sub-pattern 49 forms at least one resonant circuit 50 with arm sections of the corresponding dipole arms 31, 32, 33, and 34, respectively. As such, the multi-stage resonant circuit 50 between the dipole arms 31, 32, 33, and 34 and the corresponding pattern portion 42 may be formed by a plurality of resonant circuits 50 in series.

Additionally, or alternatively, the first radiating element 20 may have multi-band cloaking performance or wide-band cloaking performance. Referring to FIG. 8A, the pattern portion 42 of the parasitic metal pattern 40 may include a first sub-pattern 49-1 and a second sub-pattern 49-2 different from the first sub-pattern 49-1, thereby forming a first resonant circuit having a first frequency characteristic between the dipole arms 31, 32, 33, and 34 and the first sub-pattern 49-1, and forming a second resonant circuit having a second frequency characteristic between the radiating arm of the radiator 30 and the second sub-pattern 49-2. For example, the first resonant circuit may be configured to allow an operating current on the dipole arm within the first operating frequency band to pass, but prevent currents from being induced on the dipole arm within a third operating frequency band. The second resonant circuit may be configured to allow an operating current on the dipole arm within the first operating frequency band to pass, but prevent currents from being induced on the radiating arm within a fourth operating frequency band. As such, the first radiating element 20 may not only have cloaking performance for electromagnetic radiation within the third operating frequency band but also for electromagnetic radiation within the fourth operating frequency band.

It should be understood that the difference between the first sub-pattern 49-1 and the second sub-pattern 49-2 may include, but is not limited to: the overlap area between first coupling section 36 and the second coupling section 46, a thickness and a dielectric constant of the dielectric substrate 22, a design parameter of the inductive stub 48, and/or a design parameter of the capacitive arm section 39 of the dipole arm.

In some embodiments, referring to FIG. 8A, the area of the second coupling section 46 of the first sub-pattern 49-1 may be greater than the area of the second coupling section 46 of the second sub-pattern 49-2, so that the overlap area between the first coupling section 36 and the second coupling section 46 of the first sub-pattern 49-1 increases, thereby increasing a coupling capacitance.

In some embodiments, the dielectric constant of the dielectric structure between the second coupling section 46 of the first sub-pattern 49-1 and the first coupling section 36 of the corresponding dipole arm may be different from the dielectric constant of the dielectric structure between the second coupling section 46 of the second sub-pattern 49-2 and the first coupling section 36 of the corresponding dipole arm. This can be achieved, for example, by using different types of dielectric structures or by applying additional dielectric layers. In some embodiments, the length and/or the shape of the inductive stub 48 of the first sub-pattern 49-1 may be different from the length and/or the shape of the inductive stub 48 of the second sub-pattern 49-2.

In some embodiments, the cloaking performance of the first radiating element 20 may only be generated by the resonant circuit 50 formed between the parasitic metal pattern 40 and the dipole arms 31, 32, 33, and 34. In other words, the dipole arms 31, 32, 33, and 34 of the first radiating element 20 may be used as non-cloaking dipole arms and no longer have a choke, thereby basically eliminating the negative impact caused by the choke. As shown in FIG. 4, the dipole arms 31, 32, 33 and 34 of the first radiating element 20 are configured as continuous radiating arms without any choke.

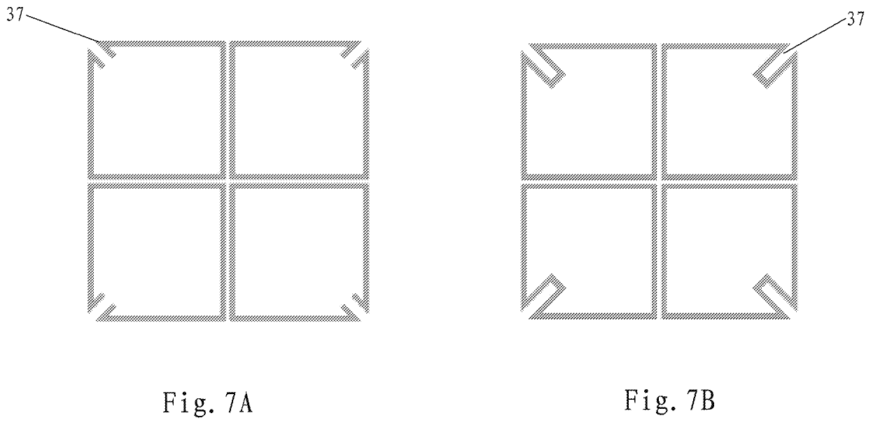

In some embodiments, the cloaking performance of the first radiating element 20 may be generated not only by the choke but also by the resonant circuit 50 formed between the parasitic metal pattern 40 and the dipole arms 31, 32, 33, and 34. In this case, the dipole arms of the first radiating element 20 may have a smaller number of chokes. For example, each dipole arm may have fewer than three or two chokes, thereby reducing the negative impact of the choke. As shown in FIG. 7A and FIG. 7B, a choke 37 is introduced in each of the dipole arms 31, 32, 33, and 34, and may be arranged, for example, at the distal end of the dipole arm 31, 32, 33, or 34.

The radiating element of the present disclosure may effectively reduce undesired scattered electromagnetic radiation based on the resonant circuit 50 formed between the parasitic metal pattern 40 and the radiator 30. In some embodiments, power of scattered electromagnetic radiation generated by the radiating element within the second operating frequency band without the parasitic metal pattern 40 is P1 (first power). Under the same radiating element with the parasitic metal pattern 40, power of scattered electromagnetic radiation generated by the radiating element within the second operating frequency band is P2 (second power). Based on the resonant circuit 50 formed between the parasitic metal pattern 40 and the radiator 30, the second power is attenuated by at least 3 dB, 4 dB, 5 dB, or 6 dB relative to the first power.

Next, referring to FIGS. 9 to 11, a schematic perspective view of a radiating element 20′ according to some other embodiments of the present disclosure is introduced. It should be understood that the above-mentioned content introduced with respect to the radiating element 20 may be directly transferred to this embodiment, and it will not be repeated here unless there is a conflict.

In the illustrated implementation, the radiating element 20′ may include a radiator 30′ and a parasitic metal pattern 40′. Each dipole arm 31′, 32′, 33′, or 34′ of the radiator 30′ may be a petal-shaped dipole arm, and each dipole arm 31′, 32′, 33′, or 34′ may be a continuous dipole arm without a choke. A pattern portion 42′ corresponding to each dipole arm 31′, 32′, 33′, or 34′ may also have a substantially petal-shaped profile so as to form a desired resonant circuit between the dipole arm and the corresponding pattern portion 42′.

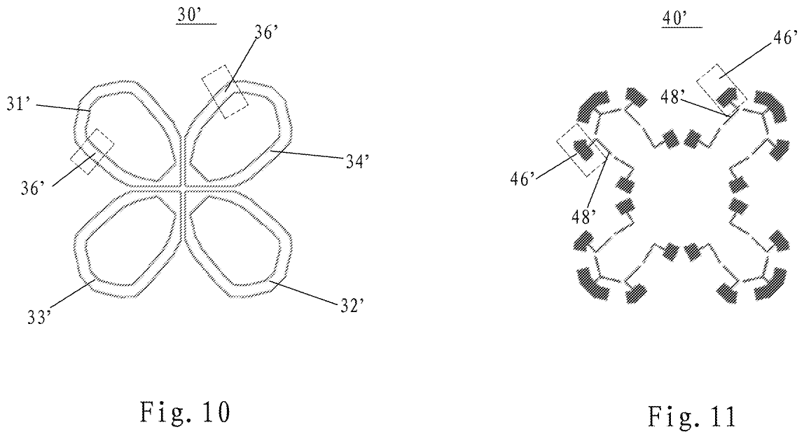

As shown in FIGS. 9-10, the radiating arms 31′, 32′, 33′, and 34′ may each include a first coupling section 36′. The parasitic metal pattern 40′ may include a second coupling section 46′ that at least partially overlaps with first coupling section 36′ in the forward direction F. As such, the first coupling section 36′, the second coupling section 46′, and a dielectric substrate 22′ therebetween may form a plate capacitor. An inductor (hereinafter referred to as a first inductor) in the LC series circuit may be formed by inductive sections 48′ in the pattern portions 42′. These inductive sections 48′ may be inductive stubs, or bent inductive traces. The capacitor in parallel with the LC series circuit may be formed by a predetermined-length arm section of the dipole arm.

It should be understood that a frequency characteristic of the resonant circuit 50′ may be related to an overlap area between the first coupling section 36′ and the second coupling section 46′, a thickness and a dielectric constant of the dielectric substrate 22′, a design parameter of the inductive stub, and/or a design parameter of the capacitive arm section of the dipole arm. In some embodiments, the resonant circuit may be a band-pass resonant circuit, such that the first operating frequency band is within a passband of the resonant circuit (for example, a 3 dB passband), and the second operating frequency band is outside the passband of the resonant circuit. For example, in order to increase the “plate capacitor”, the overlap area between the first coupling section 36′ and the second coupling section 46′ may be widened. For this purpose, the first coupling section 36′ of the radiating arm and/or the second coupling section 46′ of the parasitic metal pattern 40′ may be increased.

Although exemplary embodiments of the present disclosure have been described, those skilled in the art should understand that many variations and modifications are possible in the exemplary embodiments without materially departing from the spirit and scope of the present disclosure. Therefore, all variations and changes are included in the protection scope of the present disclosure defined by the claims. The present disclosure is defined by the attached claims, and equivalents of these claims are also included.

1. A radiating element, comprising:
a radiator with a radiating arm, the radiator configured to emit first electromagnetic radiation within a predetermined first operating frequency band; and
a parasitic metal pattern, wherein a resonant circuit is formed between the radiating arm of the radiator and the parasitic metal pattern, wherein the resonant circuit is configured to allow an operating current on the radiating arm and within the first operating frequency band to pass, but prevent an inductive current inducted on the radiating arm and within a second operating frequency band.

2. The radiating element according to claim 1, wherein the resonant circuit comprises:
an LC series circuit comprising a first inductor and a first capacitor; and
a second capacitor in parallel with the LC series circuit.

3. The radiating element according to claim 2, wherein the radiating arm comprises a first coupling section and the parasitic metal pattern comprises a second coupling section, and the first coupling section and the second coupling section overlap each other to form the first capacitor.

4. The radiating element according to claim 3, wherein the radiating arm comprises a capacitive section that functions as the second capacitor, and the parasitic metal pattern comprises an inductive section that functions as the first inductor.

5. The radiating element according to claim 1, wherein a multi-stage resonant circuit is formed between each radiating arm of the radiator and the parasitic metal pattern.

6. The radiating element according to claim 5, wherein the multi-stage resonant circuit comprises a plurality of resonant circuits in series with each other.

7. The radiating element according to claim 4, wherein the inductive section of the parasitic metal pattern is configured as an inductive stub.

8. The radiating element according to claim 1, wherein the resonant circuit is configured as a band-pass resonant circuit.

9-11. (canceled)

12. The radiating element according to claim 1, wherein the radiating element comprises a dielectric substrate, the radiator is arranged on a first major surface of the dielectric substrate, and the parasitic metal pattern is arranged on a second major surface of the dielectric substrate.

13-26. (canceled)

27. A radiating element, comprising:
a dielectric substrate;
a radiator arranged on a first major surface of the dielectric structure, the radiator configured to emit first electromagnetic radiation within a predetermined first operating frequency band; and
a parasitic metal pattern arranged on a second major surface of the dielectric structure, the parasitic metal pattern configured to interact with the radiator electromagnetically for inhibiting an inductive current induced on the radiator and within a second operating frequency band.

28. The radiating element according to claim 27, the radiator is printed on a first major surface of the dielectric substrate, and the parasitic metal pattern is printed on a second major surface of the dielectric substrate.

29. The radiating element according to claim 27, wherein a radiating arm of the radiator is configured as an annular radiating arm.

30. The radiating element according to claim 29, wherein the radiating arm does not have a choke.

31. (canceled)

32. The radiating element according to claim 27, wherein at least one resonant circuit is formed between each radiating arm of the radiator and the parasitic metal pattern, and the resonant circuit is configured to allow an operating current on the radiating arm within the first operating frequency band to pass, but prevent an inductive current induced on the radiating arm and within the second operating frequency band.

33. The radiating element according to claim 32, wherein a plurality of resonant circuits are formed between each radiating arm of the radiator and the parasitic metal pattern.

34. The radiating element according to claim 27, wherein the resonant circuit comprises:
an LC series circuit comprising a first inductor and a first capacitor; and/or
a second capacitor in parallel with the LC series circuit.

35. The radiating element according to claim 34, wherein
the radiating arm comprises a first coupling section and the parasitic metal pattern comprises a second coupling section, and the first coupling section and the second coupling section overlap each other to form the first capacitor; and
the radiating arm comprises a capacitive section that functions as the second capacitor, and the parasitic metal pattern comprises an inductive section that functions as the first inductor.

36. The radiating element according to claim 27, wherein the radiating element comprises:
a first dipole radiator comprising a first dipole arm and a second dipole arm; and
a second dipole radiator comprising a third dipole arm and a fourth dipole arm; wherein
the parasitic metal pattern comprises a first pattern portion for the first dipole arm, a second pattern portion for the second dipole arm, a third pattern portion for the third dipole arm, and a fourth pattern portion for the fourth dipole arm.

37. The radiating element according to claim 36, wherein the various pattern portions are separated from each other.

38-39. (canceled)

40. A base station antenna, comprising: a first radiating element array configured to emit first electromagnetic radiation within a pre-determined first operating frequency band, wherein at least a part of first radiating elements in the first radiating element array is constructed as the radiating element according to Claim 1; and a second radiating element array, configured to emit second electromagnetic radiation within a pre-determined second operating frequency band.
